(19) United States
(12) Patent Application Publication
(10) Pub. No.: US 2026/0237186 A1
(43) Pub. Date: Aug. 13, 2026

(54) Map Information Processing Device

(71) Applicant: Hitachi, Ltd., Chiyoda-ku, Tokyo (JP)

(72) Inventors: Tadashi KOTANI, Tokyo (JP); Hiroyuki YAMADA, Tokyo (JP); Noriyasu HASEJIMA, Tokyo (JP); Kazuya MUROTANI, Tokyo (JP); Yuto IMANISHI, Tokyo (JP); Tsuyoshi KITAMURA, Tokyo (JP)

(21) Appl. No.: 19/154,984

(22) PCT Filed: Apr. 4, 2024
(86) PCT No.: PCT/JP2024/013907

§ 371 Date: Aug. 8, 2025

(30) Foreign Application Priority Data
Apr. 28, 2023 (JP) 2023-075099

(51) Int. Cl. G06V 10/764; G06V 10/26; G06V 10/44; G06V 20/10; G06V 20/64

(52) U.S. Cl. CPC G06V 10/764; G06V 10/26; G06V 10/44; G06V 20/176; G06V 20/182; G06V 20/64

(57) ABSTRACT

A map information processing device according to the present disclosure comprises: a point cloud map acquisition unit that acquires a point cloud map; a survey map acquisition unit that acquires a survey map including the contour of a structure; a boundary contour extraction unit that creates a closed curve of the boundary of the structure from the survey map; and a structure point cloud extraction unit that extracts, as a structure point cloud, a remaining point cloud obtained by removing a point cloud within the closed curve of the boundary of the structure from the point cloud map.

### TECHNICAL FIELD

The present invention relates to a map information processing apparatus which labels a structure on a point cloud map.

### BACKGROUND ART

There have been proposed, for example, various techniques of classifying or extracting a desired structure such as a road or a building from a point cloud map. Patent Literature 1 discloses a technique in which, in an information processing apparatus which generates boundary position information indicating the position of a boundary of a road such as a lane marker or a road shoulder edge used as map information, perpendicular lines are drawn at equal intervals on the road boundary of the map, and a point having a large change in height or brightness in a point cloud on the perpendicular lines is extracted and set as a road end.

### CITATION LIST

### Patent Literature

Patent Literature 1: Japanese Unexamined Patent Application Publication No. 2022-89828

### SUMMARY OF INVENTION

### Technical Problem

In the technique of Patent Literature 1, when the change in height or brightness is small in the point cloud on the perpendicular line, the road end cannot be accurately recognized. Further, it is necessary to determine a change in height or brightness for all the points of the point cloud, and a processing load is large.

The present invention has been made in view of the above points, and its object is to provide a map information processing apparatus capable of easily performing labeling to classify structures such as a road, a building, etc. on a point cloud map.

### Solution to Problem

In order to solve the above problems, a map information processing apparatus of the present invention includes: a point cloud map acquisition unit configured to acquire a point cloud map; a survey map acquisition unit configured to acquire a survey map including boundary information on a structure; a boundary contour extraction unit configured to create a structure boundary closed curve from the survey map; and a structure point cloud extraction unit configured to extract a point cloud by an inside/outside determination as to whether the point cloud included in the point cloud map exists either inside or outside the structure boundary closed curve, and classify the extracted point cloud into a structure point cloud.

### Advantageous Effects of Invention

According to the present invention, it is possible to obtain a map information processing apparatus capable of easily performing labeling to classify structures such as a road, a building, etc. on a point cloud map.

Further features concerning the present invention will be clarified from the content of this description and the accompanying drawings. Objects, configurations, and effects other than the above will be apparent from the description of the following embodiments.

### BRIEF DESCRIPTION OF DRAWINGS

FIG. 1 is a functional block diagram of a map information processing apparatus according to a first embodiment.

FIG. 2 is a diagram showing an example in which a survey map is displayed in a plane coordinate format.

FIG. 3 is a diagram showing an example in which a survey map is displayed in a data format.

FIG. 4 is a diagram showing a point cloud map in a three-dimensional format.

FIG. 5 is a diagram showing a point cloud map in a data format.

FIG. 6 is a flowchart showing processing of a point cloud map region extraction unit.

FIG. 7 is a diagram showing an example of extracting a road region from a point cloud map using road boundary information.

FIG. 8 is a flowchart showing the contents of boundary closed curve polygon extraction processing in a boundary contour extraction unit.

FIG. 9 is a flowchart showing the contents of extraction processing S630 of a building boundary closed curve polygon in the boundary contour extraction unit.

FIG. 10 is a diagram showing an example of a point sequence of a building boundary.

FIG. 11 is a flowchart showing the contents of extraction processing S640 of a road boundary closed curve polygon in the boundary contour extraction unit.

FIG. 12 is a diagram showing an example of a point sequence of a road boundary extracted in S830.

FIG. 13 is a flowchart showing the contents of processing of creating a road boundary closed curve polygon in S840.

FIG. 14 is a diagram showing an example of creating a road boundary closed curve polygon.

FIG. 15 is a flowchart showing processing of a building point cloud extraction unit.

FIG. 16 is a diagram describing a modification of the processing of the boundary contour extraction unit.

FIG. 17 is a flowchart showing processing of a road point cloud extraction unit.

FIG. 18 is an image diagram showing on a survey map, a state in which a point cloud included in the road boundary closed curve polygon is removed from a point cloud on a ground surface.

FIG. 19 is a flowchart showing processing of a point cloud reclassification unit.

FIG. 20 is an explanatory diagram showing an effect of the point cloud reclassification unit.

FIG. 21 is an explanatory diagram showing a second embodiment.

FIG. 22 is an explanatory diagram showing a third embodiment.

FIG. 23 is a flowchart showing processing of a road point cloud extraction unit according to the third embodiment.

### DESCRIPTION OF EMBODIMENTS

Embodiments of the present invention will now be described with reference to the drawings. Note that in each of the following embodiments, a road and a building will be described as examples of structures to be labeled, but any one of the structures may be labeled, and the concept of the present invention also includes a case in which only another structure is labeled or another structure is additionally labeled.

### First Embodiment

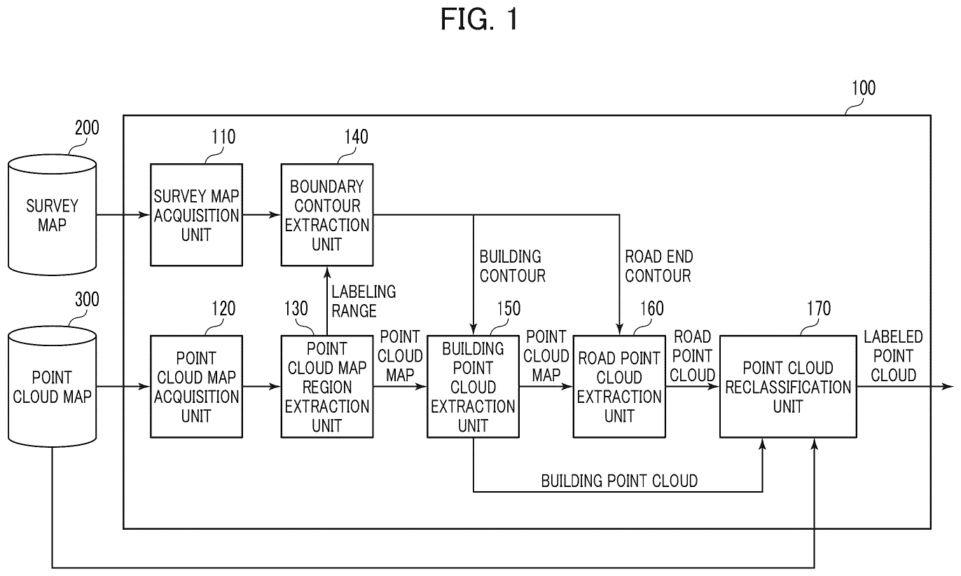

FIG. 1 is a functional block diagram of a map information processing apparatus according to a first embodiment.

The map information processing apparatus 100 is an apparatus which performs labeling for classifying structures such as a road and a building for each point of a point cloud map. The map information processing apparatus 100 includes a processor such as a CPU (Central Processing Unit), and a memory such as a RAM (Random Access Memory) and a ROM (Read Only Memory). Further, the map information processing apparatus 100 is constituted by a computer system equipped with input/output devices such as a mouse, a keyboard, and a display, and a communication device (none of which are shown).

The map information processing apparatus 100 is connected to a survey map database 200 and a point cloud map database 300, and can transmit and receive data to and from these databases. The survey map database 200 stores a survey map 201 therein, and the point cloud map database 300 stores a point cloud map 301 therein.

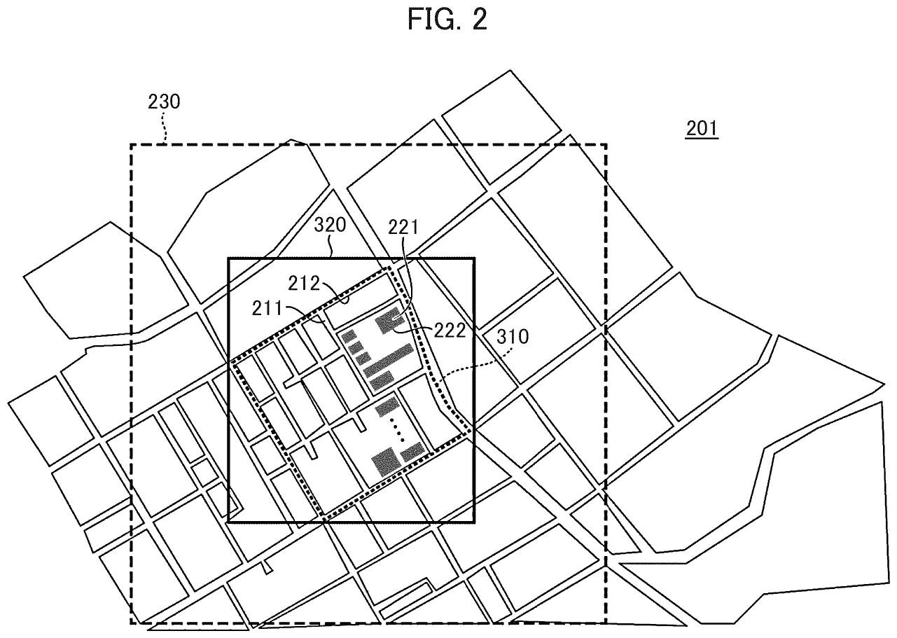

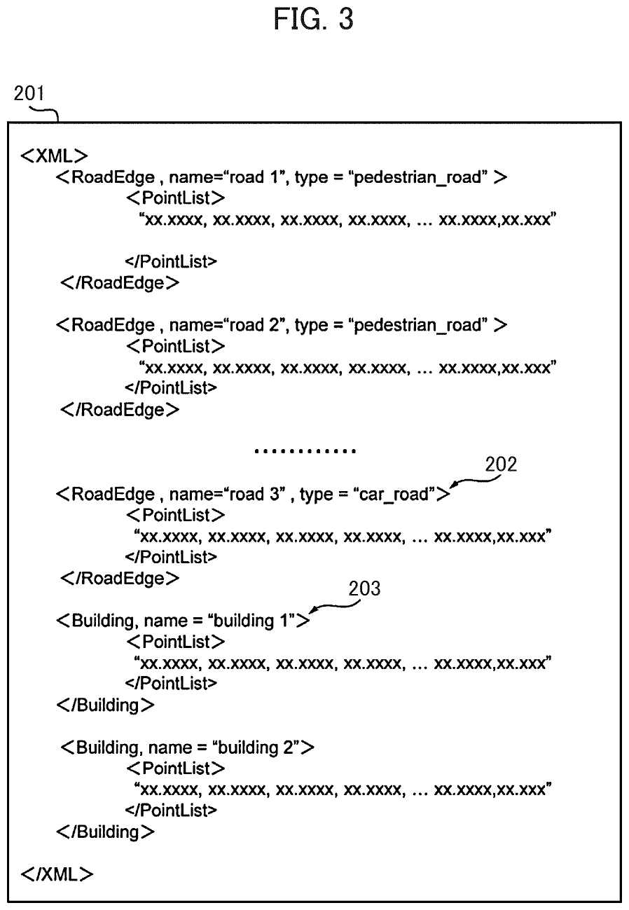

FIGS. 2 and 3 show examples of a survey map stored in the survey map database. FIG. 2 is a diagram showing an example in which the survey map is displayed in a plane coordinate format, and FIG. 3 is a diagram showing an example in which the survey map is displayed in a data format.

The survey map 201 is a two-dimensional (2D) planar map such as a topographic map. As shown in FIG. 2, the survey map 201 includes boundary information on structures such as at least a road boundary (road end contour) 212 of a road 211 and a building boundary (building contour) 222 of a building 221. As shown in FIG. 3, the survey map 201 is stored in the survey map database 200 in a data format such as an XML format. The data of the survey map 201 includes information such as the type of the structure, e.g., whether the structure is the road 211 or the building 221. Also, the data of the survey map 201 includes a section 202 indicating a road boundary (RoadEdge herein) and a section 203 indicating a building boundary (Building), and each boundary is held therein as a point sequence. Then, the data of the survey map 201 includes names of the road 211 and the building 221, and information on attributes indicating a roadway and a sidewalk of the road 211.

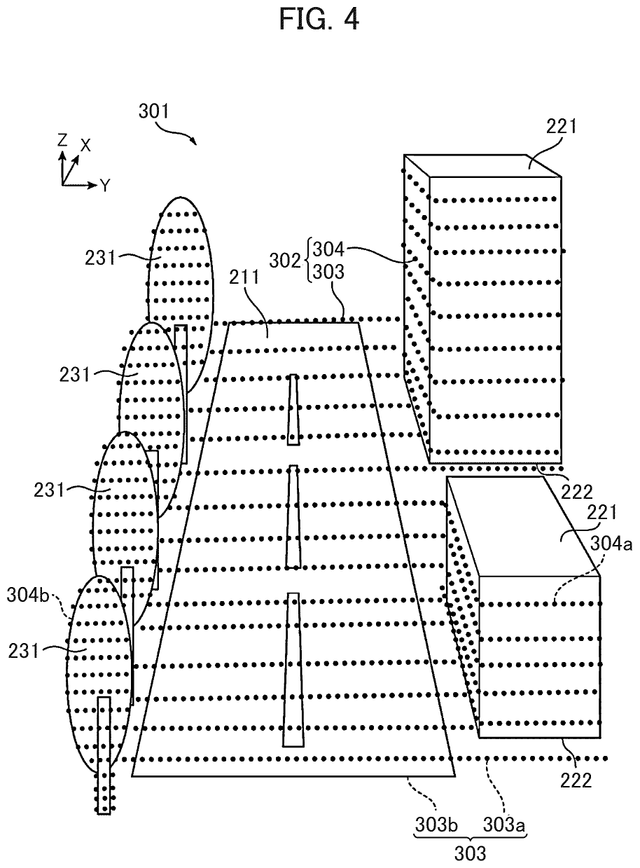

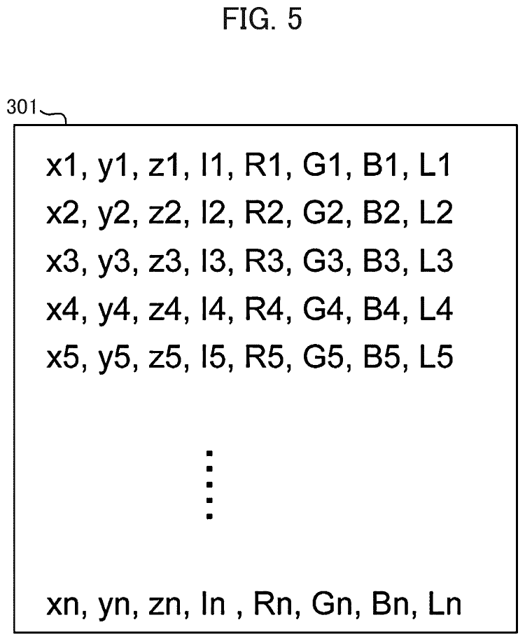

FIGS. 4 and 5 show examples of the point cloud map stored in the point cloud map database. FIG. 4 is a diagram showing the point cloud map in a three-dimensional (3D) format, and FIG. 5 is a diagram showing the point cloud map in a data format.

The point cloud map 301 is a set of three-dimensional measurement points obtained by measuring an urban area or a town area with a measurement device such as a LiDAR or a camera and formulated using SLAM (Simultaneous Localization and Mapping). The point cloud map 301 includes therein a plurality of measurement points (hereinafter referred to as a point cloud) 302 obtained by measuring three-dimensional shapes of a road 211, a building 221, a street tree 231, and the like. A measurement apparatus which measures a three-dimensional shape is mounted on a moving body such as an automobile, an airplane, or a drone, and performs measurements by moving these moving bodies. The point cloud map 301 is an environmental map of a three-dimensional (3D) point cloud using an orthogonal coordinate system as a reference coordinate system.

The point cloud map 301 is stored as, for example, a text file as shown in FIG. 5. The data of each measurement point of the point cloud 302 may include color information (Rn, Gn, Bn) and information (In) related to reflection intensity in addition to position information (Xn, Yn, Zn). Note that the label information output in the present embodiment can be held by assigning label information Ln in which a building, a road, or the like is associated with an integer to each measurement point. That is, each measurement point of the point cloud is given the label information Ln indicating the classification of the building or the road.

Various functions of the map information processing apparatus 100 are realized by hardware such as a CPU reading and executing a software program stored in a memory such as a RAM or a ROM. As shown in FIG. 1, the map information processing apparatus 100 includes a survey map acquisition unit 110, a point cloud map acquisition unit 120, a point cloud map region extraction unit 130, a boundary contour extraction unit 140, a building point cloud extraction unit 150, a road point cloud extraction unit 160, and a point cloud reclassification unit 170 as functions implemented by execution of the software program.

The survey map acquisition unit 110 acquires the survey map 201 from the survey map database 200. Then, the point cloud map acquisition unit 120 acquires the point cloud map 301 from the point cloud map database 300. The survey map acquisition unit 110 acquires a survey map in a survey map acquisition region 230. The survey map acquisition unit 110 acquires the attribute of a structure from the survey map. The range of the survey map acquisition region 230 acquired by the survey map acquisition unit 110 is set based on a point cloud acquisition region 320 output by the point cloud map region extraction unit 130 to be described later. As will be described later, in the present embodiment, in order to perform labeling of the point cloud map 301, road boundary information of a wider area than the point cloud acquisition region 320 is required. Therefore, it is necessary to set the survey map acquisition region 230 larger than the point cloud acquisition region 320. The range of the survey map acquisition region 230 depends on the road shape and the map, but it is desirable to set about three to ten times the point cloud acquisition region 320 as the survey map acquisition region 230.

The point cloud map region extraction unit 130 sets a labeling range 310 in which each measurement point of the point cloud is labeled in the point cloud map 301, and sets a rectangle including the labeling range 310 as the point cloud acquisition region 320.

The boundary contour extraction unit 140 extracts a closed curve of a structure boundary from the survey map 201. The boundary contour extraction unit 140 creates a closed curve of a structure boundary based on the attribute of the structure included in the survey map 201. For example, the boundary contour extraction unit 140 performs processing of extracting a road boundary closed curve polygon (road boundary closed curve) 210 of a road end contour of the road 211 being the first structure and a building boundary closed curve polygon (building boundary closed curve) 220 of a building contour of the building 221 being the second structure as closed curves of structure boundaries from the survey map 201. The boundary contour extraction unit 140 extracts a point sequence of the road boundary 212 from the survey map 201 using the road boundary information on the survey map 201. Then, the end points of the point sequences adjacent to each other of the multiple road boundaries 212 are connected to each other to create a road boundary closed curve polygon 210 comprised of a closed curve of the road end contour. Further, the boundary contour extraction unit 140 extracts a point sequence related to the building from the survey map 201 using the building boundary information on the survey map 201, and creates a building boundary closed curve polygon 220 formed of a closed curve indicating the building contour of the building 221.

The building point cloud extraction unit 150 and the road point cloud extraction unit 160 extract a point cloud of a structure using the closed curve of the structure boundary created by the boundary contour extraction unit 140. The building point cloud extraction unit 150 and the road point cloud extraction unit 160 extract a point cloud by an inside/outside determination as to whether the point cloud 302 included in the point cloud map 301 is present inside or outside the closed curve of the structure boundary, and classify the extracted point cloud into a structure point cloud. Each of the building point cloud extraction unit 150 and the road point cloud extraction unit 160 constitutes a structure point cloud extraction unit of Claim 1.

The building point cloud extraction unit 150 performs labeling for classifying the point cloud 302 in the labeling range 310 of the point cloud map 301 into the point cloud 303 of the ground surface and the point cloud 304 of the ground object by using the building boundary information on the survey map 201. This classification may be performed by the road point cloud extraction unit 160 to be described later.

The building point cloud extraction unit 150 extracts a point cloud included inside the building boundary closed curve polygon 220 from the point cloud 304 classified as a ground object, and performs labeling to classify the extracted point cloud into a building point cloud (structure point cloud) 304a. Further, the point cloud 304b positioned outside the building boundary closed curve polygon 220 remaining after the building point cloud 304a is removed from the point cloud 304 of the ground object may be labeled to be classified into another structure point cloud such as the street tree 231.

The road point cloud extraction unit 160 removes a point cloud 303a inside the road boundary closed curve polygon 210 included in the road boundary closed curve polygon 210 from the point cloud 303 classified into the ground surface, extracts the remaining point cloud, i.e., the point cloud located outside the road boundary closed curve polygon 210 in the point cloud 303, and performs labeling to classify the extracted point cloud into the road point cloud (structure point cloud) 303b.

The point cloud reclassification unit 170 creates a classifier using the point cloud map 301 in which each measurement point of the point cloud 302 is labeled, as teacher data for machine learning. Then, the entire point cloud map 301 to be labeled is input to the classifier, and the point cloud 302 is reclassified and output as a labeled point cloud. As a machine-learning method, a method such as Random Forest or a technology such as Semantic Segmentation can be utilized.

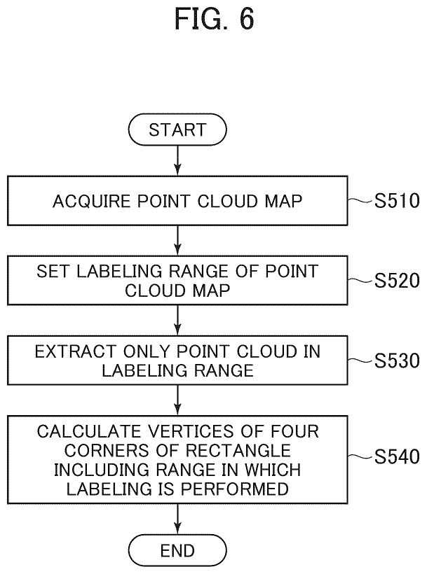

Next, a description will be made about a method of processing map information using the map information processing apparatus according to the present embodiment. FIG. 6 is a flowchart showing processing of the point cloud map region extraction unit.

The point cloud map region extraction unit 130 acquires the point cloud map 301 from the point cloud map acquisition unit 120 (S510), and sets a labeling range 310 in which labeling is performed in the acquired point cloud map 301 (S520). Then, only the point cloud 302 existing in the labeling range 310 is extracted (S530). Then, a rectangle including the labeling range 310 is set as the point cloud acquisition region 320 (S540). Specifically, the point cloud map region extraction unit 130 calculates the vertexes 320a of the four corners of the point cloud acquisition region 320. The point cloud acquisition region 320 is used to calculate the survey map acquisition region 230.

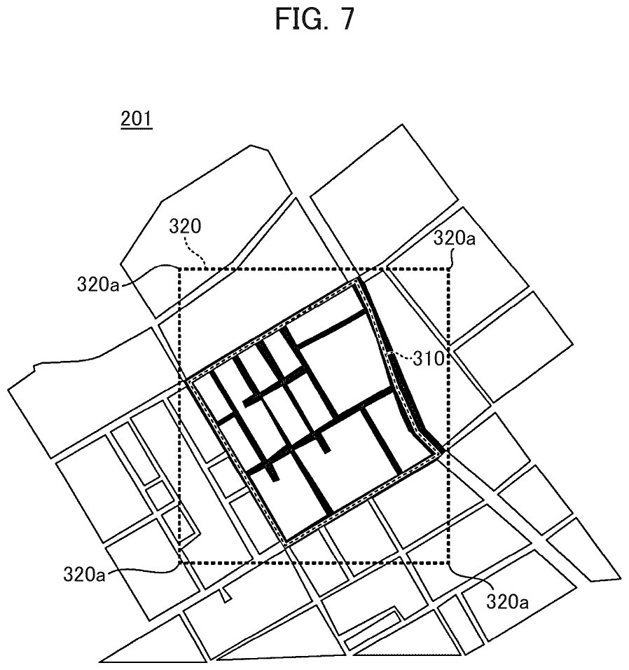

FIG. 7 is a diagram showing an example of extracting a road region from a point cloud map using road boundary information.

In the example shown in FIG. 7, a labeling range 310 is shown on the survey map 201. The point cloud map region extraction unit 130 extracts information about the point cloud 302 existing in the labeling range 310 from the point cloud map 301 and supplies it to the boundary contour extraction unit 140. The labeling range 310 does not need to be along the road as shown in FIG. 7 and can be set to any shape, and may be, for example, a rectangle equivalent to the point cloud acquisition region 320.

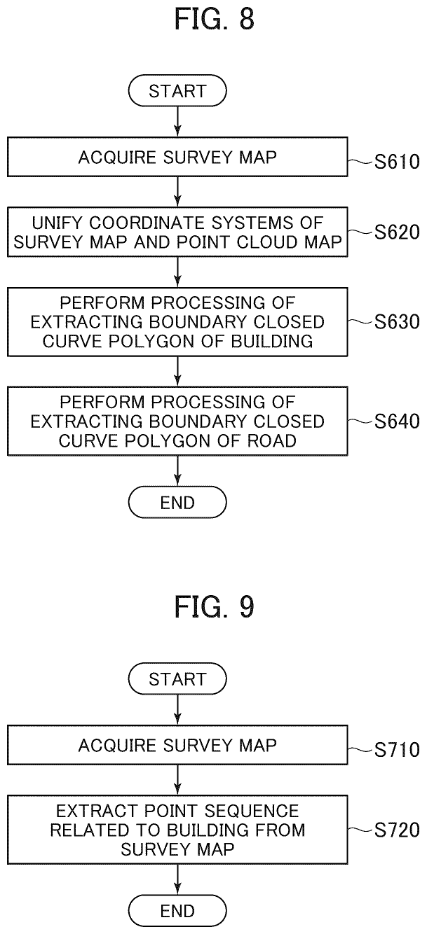

FIG. 8 is a flowchart showing the contents of the extraction processing of the boundary closed curve polygon in the boundary contour extraction unit.

When the boundary contour extraction unit 140 acquires the survey map from the survey map acquisition unit 110 (S610) and acquires the information about the point cloud in the point cloud acquisition region 320 from the point cloud map region extraction unit 130, coordinate systems of the survey map 201 and the point cloud map 301 are unified (S620). Then, the boundary contour extraction unit 140 performs processing of extracting the building boundary closed curve polygon 220 of the building 221 (S630) and processing of extracting the road boundary closed curve polygon 210 of the road 211 (S640).

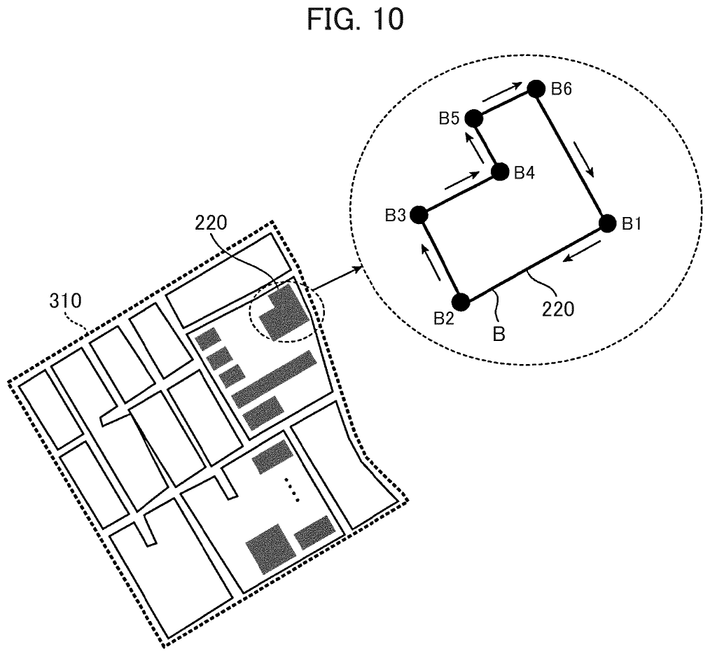

FIG. 9 is a flowchart showing the contents of the extraction processing S630 of the building boundary closed curve polygon in the boundary contour extraction unit.

When acquiring the survey map from the survey map acquisition unit 110 (S710), the boundary contour extraction unit 140 extracts a point sequence related to the building boundary 222 in the labeling range 310 of the point cloud map 301 from the building boundary information on the survey map 201 (S720). The point sequence related to the building boundary 222 has a closed curve along the shape (contour) of the building 221 when the building 221 is viewed in plan view, and the closed curve is extracted as the building boundary closed curve polygon 220.

FIG. 10 is a diagram showing an example of a point sequence of a building boundary.

The building boundary information on the survey map 201 is often held as a point sequence in a clockwise or counterclockwise direction. In the example shown in FIG. 10, the boundary contour extraction unit 140 starts from a point B1 of the building boundary information, moves clockwise to points B2 to B6, and extracts a closed curve formed by a point sequence B which connects from the points B6 to B1 again as the building boundary closed curve polygon 220. In the point cloud extraction of the building point cloud extraction unit 150 to be described later, it is possible to determine whether or not the point cloud in the labeling range 310 is the point cloud of the building 221 by determining whether XY coordinates of each point exist either inside or outside the building boundary closed curve polygon 220 constituted by the point sequence B of the building 221.

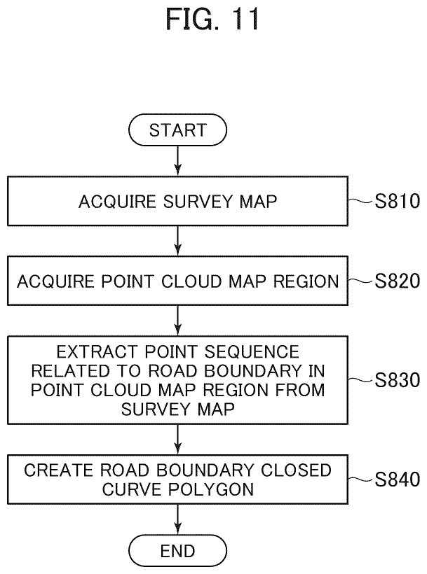

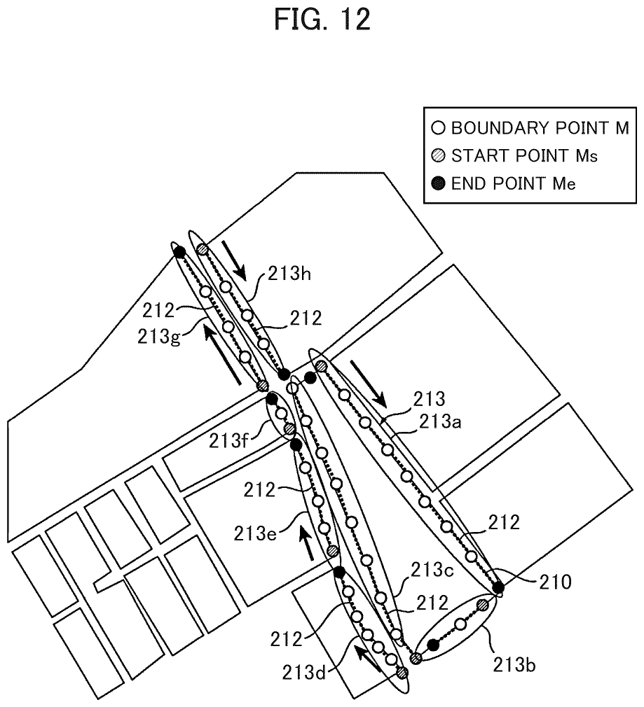

FIG. 11 is a flowchart showing the contents of the extraction processing S640 of the road boundary closed curve polygon in the boundary contour extraction unit.

The boundary contour extraction unit 140 acquires the survey map 201 from the survey map acquisition unit 110 (S810), and acquires the point cloud acquisition region 320 from the point cloud map region extraction unit 130 (S820). Then, the boundary contour extraction unit 140 extracts the point sequence 213 related to the road boundary 212 in the point cloud acquisition region 320 of the point cloud map 301 from the road boundary information on the survey map 201 (S830). Then, the end points of the point sequences 213 adjacent to each other of the plurality of road boundaries 212 are connected to each other to create a road boundary closed curve polygon 210 formed of a closed curve of the road end contour (S840).

FIG. 12 is a diagram showing an example of the point sequence of the road boundary extracted in S830.

The road boundaries 212 in the survey map 201 are often held as a substantially linear point sequence 213 in which boundary points M are arranged in order from a start point Ms to an end point Me. The boundary contour extraction unit 140 extracts a plurality of point sequences 213 related to the road boundaries 212 from the road boundary information on the survey map 201. Each boundary point M of the point sequence 213 is set with one end point of the point sequence 213 as the start point Ms and the other end point as the end point Me. In the present embodiment, a plurality of boundary points M are held as point sequences 213a to 213h, and the start point Ms and the end point Me are set so as to be continuous clockwise.

The boundary contour extraction unit 140 determines whether or not the distance of separation between the end points of the plurality of point sequences 213 is less than a threshold value Δth, and when the separation distance is less than the threshold value Δth, connects between the end points to form one point sequence 213 forming a substantially polygonal shape. Then, a start point Ms and an end point Me of one point sequence 213 forming the substantially polygonal shape are connected to create a road boundary closed curve polygon 210 of a closed curve shape.

The boundary contour extraction unit 140 performs processing of extracting end points corresponding to the start point Ms and the end point Me in each point sequence 213 of the road boundary 212, calculating a distance between the start point Ms and the end point Me, between the start points Ms, or between the end points Me of each point sequence 213, and combining the end points having a distance less than a threshold value Δth to convert the two point sequences 213 into one point sequence 213. Then, the distance between the start point Ms and the end point Me in one point sequence 213 is calculated. If the distance between the start point Ms and the end point Me of one point sequence 213 is less than the threshold value, it is then regarded as the road boundary closed curve polygon 210.

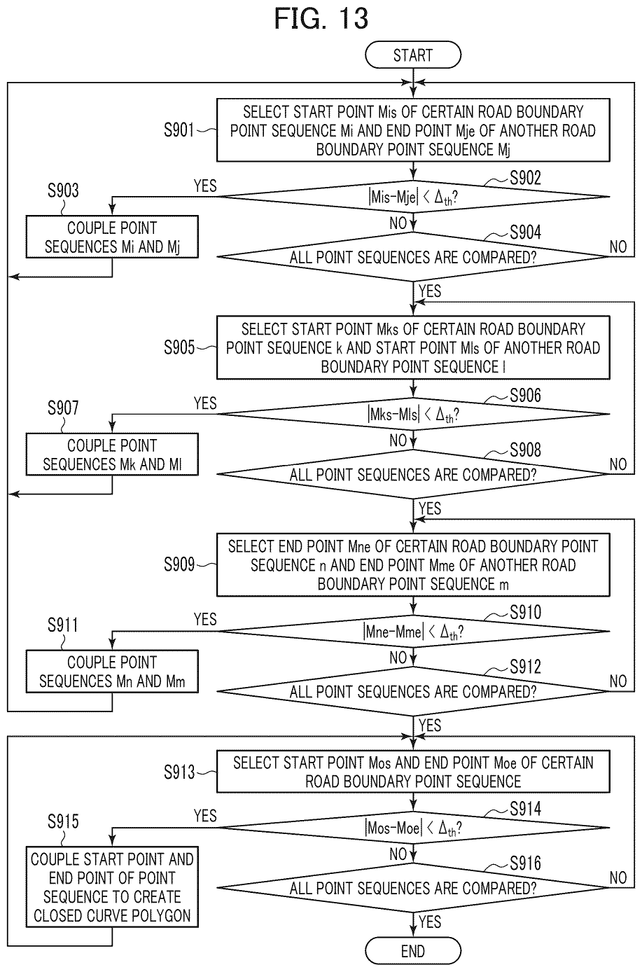

FIG. 13 is a flowchart showing the contents of the processing of creating the road boundary closed curve polygon in S840.

The boundary contour extraction unit 140 selects a start point Mis of a point sequence 213Mi of a certain road boundary 212 and an end point Mje of a point sequence 213Mj of another road boundary 212 (S901), compares the distance between the start point Mis and the end point Mje with a threshold value Δth to determine whether or not the distance is less than the threshold value Δth (S902), and couples the start point Mis of the point sequence 213Mi and the end point Mje of the point sequence 213Mj when the distance is less than the threshold value Δth (S903).

Then, when it is determined that the start point Ms and the end point Me have been compared for all the point sequences 213 (S904), the start points Ms are compared with each other, that is, the distance between the start point Mks of the point sequence 213Mk of a certain road boundary 212 and the start point Mls of the point sequence 213Ml of another road boundary 212 is compared with the threshold value Δth to determine whether or not to connect therebetween (S905 to S907). Then, when it is determined that the start points Ms of all the point sequences 213 have been compared with each other (YES in S908), the end points Me are compared with each other, that is, the distance between the end point Mne of the point sequence 213Mn of a certain road boundary and the end point Mme of the point sequence 213Mm of another road boundary 212 is compared with the threshold value Δth to determine whether or not to couple therebetween (S909 to S912). Then, when it is determined that the end points Me have been compared with each other for all the point sequences 213, the processing proceeds to S913 and thereafter in order to create a closed curve.

A start point Mos and an end point Moe of a point sequence 213Mo of a certain road boundary 212 are selected, the distance between the start point Mos and the end point Moe is compared with the threshold value Δth to determine whether or not the distance is less than the threshold value Δth (S913, S914). When the distance is less than the threshold value Δth, the start point Mos of the point sequence Mo and the end point Moe of the point sequence Mo are connected to each other to create a road boundary closed curve polygon 210 of the road boundary 212 (S915).

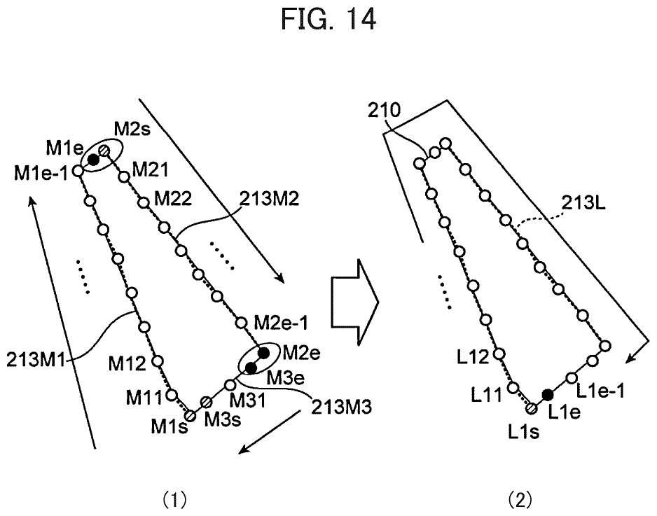

FIG. 14 is a diagram showing an example of creating a road boundary closed curve polygon. FIG. 14 (1) shows a state in which end points of each point sequence 213M1, 213M2, 213M3 constituting a plurality of road boundaries are connected to each other, and FIG. 14 (2) shows a road boundary closed curve polygon generated by the plurality of road boundaries.

The boundary contour extraction unit 140 extracts from the survey map 201, the end points M1s, M2s, M3s, M1e, M2e, and M3e corresponding to the start and end points of the point sequences 213M1 to 213M3, respectively. Then, the positions of the end points of the point sequences 213M1 to 213M3 are checked clockwise from the point sequence 213M1, and first, the distance between the end point M1e of the point sequence 213M1 and the start point M2s of the point sequence 213M2 is calculated. Then, when the distance between the end point M1e and the start point M2s is less than the threshold value Δth, the end point M1e and the start point M2s are combined to form a single point sequence in which the point sequence 213M1 and the point sequence 213M2 are connected to each other.

Next, the distance between the end point M2e of the point sequence 213M2 and the end point M3e of the point sequence 213M3 is calculated. Then, when the distance between the end point M2e and the end point M3e is less than the threshold value Δth, the end point M2e and the end point M3e are combined to form a single point sequence 213L in which the point sequence 213M1, the point sequence 213M2, and the point sequence 213M3 are connected in this order.

Then, after the processing of connecting these end points, as shown in FIG. 14 (2), the distance between the end point L1e and the start point L1s is calculated in the single point sequence 213L. If the distance between the start point L1s and the end point L1e is within the threshold value, the point sequence L1 is assumed to be a road boundary closed curve polygon 210 comprised of a road boundary 212.

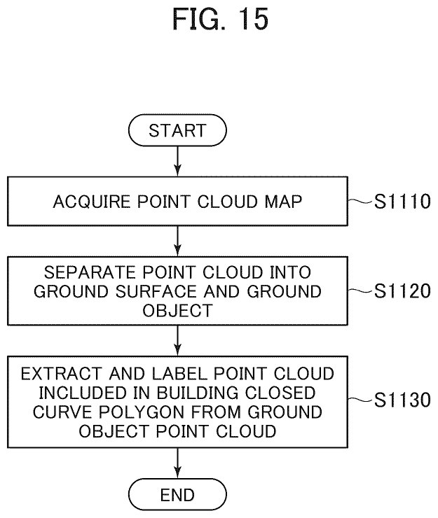

FIG. 15 is a flowchart showing processing of the building point cloud extraction unit.

The building point cloud extraction unit 150 acquires the point cloud 302 in the labeling range 310 of the point cloud map 301 from the point cloud map region extraction unit 130 (S1110). Then, the point cloud in the labeling range 310 is separated into a point cloud of the ground surface and a point cloud of the ground object (S1120). Here, the point cloud 303 of the ground surface is a point cloud obtained by measuring the ground surface such as a road. The point cloud 304 of the ground object indicates a point cloud obtained by measuring an object having a height such as a building 221 or a street tree 231. A known method can be used as a method of separating the point cloud in the point cloud acquisition region 320 into the point cloud of the ground surface and the point cloud of the ground object. Then, the point cloud included in the building boundary closed curve polygon 220 is extracted from the point cloud 303 of the ground object, and labeling for classifying the extracted point cloud into the building point cloud 303a is performed (S1130).

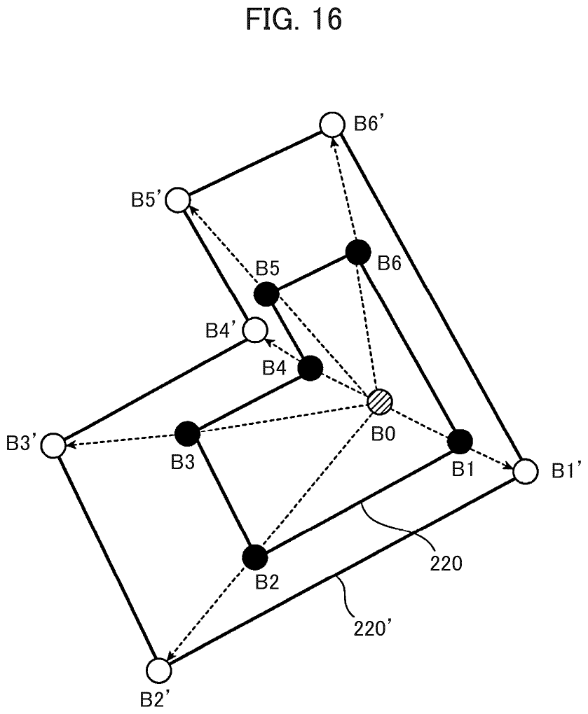

FIG. 16 is a diagram describing a modification of the processing of the boundary contour extraction unit.

As described above, the building point cloud extraction unit 150 extracts the building point cloud 304a from the point cloud map 301 using the building boundary closed curve polygon 220 extracted from the survey map 201. However, since the building contour of the building 221 such as a building has the same size as the building boundary 222, a part of the building 221 such as a lobby may be located outside the building boundary 222 when the building boundary closed curve polygon 220 indicating the building contour of the building 221 is used as it is.

In the present modification, the building boundary closed curve polygon 220 of the building boundary 222 is enlarged to obtain an enlarged building boundary closed curve polygon 220′ as shown in FIG. 16. The enlarged building boundary closed curve polygon 220′ is used to perform processing to extract the building point cloud 304a from the point cloud map 301. Consequently, a point cloud 304 obtained by measuring a building portion such as a lobby, which protrudes outward from the building boundary 222 can also be included in the building boundary closed curve polygon 220′, and can be extracted as the point cloud 304a of the building 221.

The boundary contour extraction unit 140 performs processing of enlarging the building boundary 222 created from the survey map 201 with the centroid of the building boundary closed curve polygon 220 as the center. The building point cloud extraction unit 150 extracts a point cloud existing within the building boundary closed curve polygon 220′ of the enlarged building boundary 222 from the point cloud map 301, and classifies the extracted point cloud into the building point cloud 304a.

As a method of enlarging the building boundary closed curve polygon 220, for example, a vector starting from the centroid B0 of the building boundary closed curve polygon 220 and directed toward each of the vertices B1 to B6 is calculated and multiplied by a constant. The constant is determined depending on the size of the lobby or the like protruded from the building boundary 222, but is set to about 1.2 to 1.5 times. The building point cloud extraction unit 150 performs inside/outside determination as to whether the point cloud exists either inside or outside the building boundary closed curve polygon 220′ constituted by the point sequence B having points B1′ to B6′, and determines whether or not the point cloud in the labeling range 310 is the point cloud of the building 221.

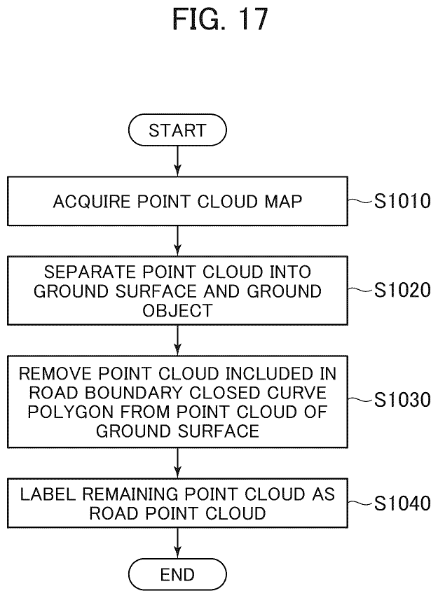

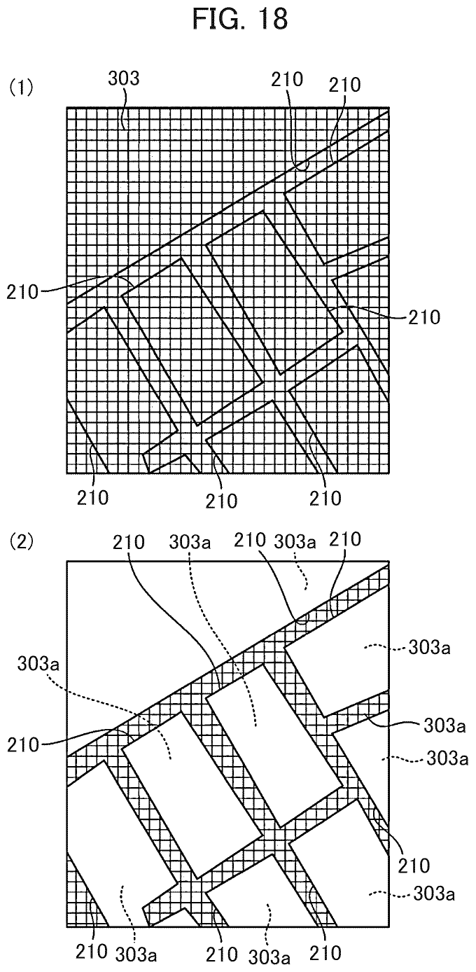

FIG. 17 is a flowchart showing the processing of the road point cloud extraction unit, and FIG. 18 is an image diagram showing on the survey map, a state in which the point cloud included in the road boundary closed curve polygon is removed from the point cloud on the ground surface.

The road point cloud extraction unit 160 acquires the point cloud 302 in the labeling range 310 of the point cloud map 301 from the point cloud map region extraction unit 130 (S1010).

Then, similarly to the processing of S1120 shown in FIG. 15 described above, the point cloud in the labeling range 310 is separated into the point cloud 303 of the ground surface and the point cloud 304 of the ground object by the known method (S1020). Then, the point cloud 303a included in the road boundary closed curve polygon 210 is removed from the point cloud 303 of the ground surface (S1030). A point cloud remaining after removing the point cloud 303a included in the road boundary closed curve polygon 210 from the point cloud 303 of the ground surface is extracted, and labeling for classifying the extracted point cloud into the road point cloud 303b is performed (S1040).

FIG. 18 (1) shows a region in which the point cloud 303 of the ground surface is arranged in the survey map 201. FIG. 18 (2) shows a region in which the road point cloud 303b remaining after removing the point cloud 303a included in the road boundary closed curve polygon 210 from the point cloud 303 of the ground surface is arranged.

When the road boundary 212 is assumed to be line information by a point sequence, it is difficult to determine which side is a road only by the line information on the road boundary 212. In the present embodiment, the road boundary closed curve polygon 210, which is the closed curve of the road boundary 212, is created by connecting the plurality of road boundaries 212, so that it can be determined that the inside of the road boundary closed curve polygon 210 is other than the road, and the outside of the road boundary closed curve polygon is the road 211. Therefore, in the labeling range 310, a region corresponding to the outside of the road boundary closed curve polygon 210 can be assumed to be a road region, and a point cloud existing in the road region can be determined as the road point cloud 303b.

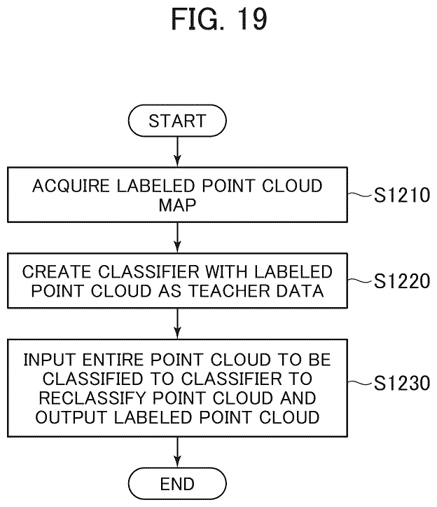

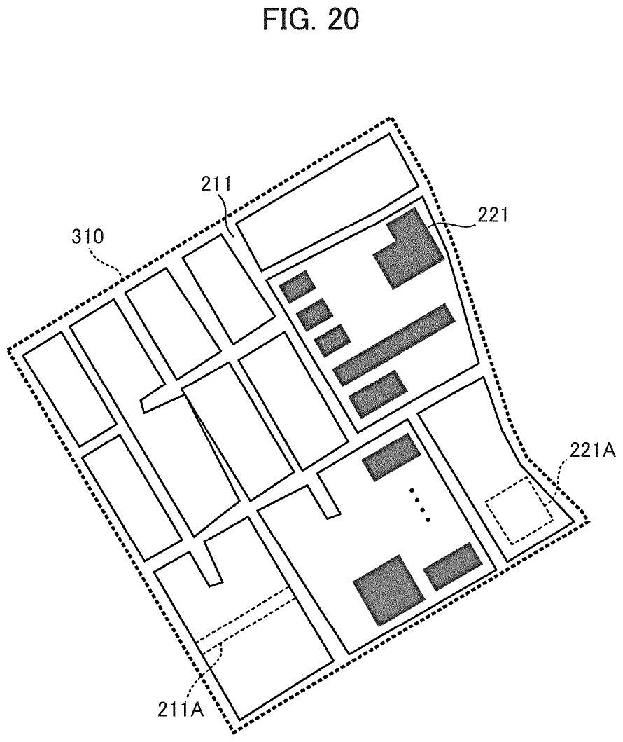

FIG. 19 is a flowchart showing the processing of the point cloud reclassification unit.

The point cloud reclassification unit 170 acquires a point cloud map 301 having a labeled point cloud (S1210). As the point cloud map 301, a point cloud map 301 having a point cloud to which labels of a road 211 and a building 221 are attached by labeling is acquired. The point cloud reclassification unit 170 creates a classifier which uses the acquired labeled point cloud as teacher data for machine learning (S1220). Then, the entire point cloud to be classified is input to the classifier to reclassify the point cloud, and a labeled point cloud after reclassification is output (S1230).

FIG. 20 is an explanatory diagram showing an effect of the point cloud reclassification unit.

In the boundary contour extraction unit 140 of the present embodiment, since the road boundary closed curve polygon 210 and the building boundary closed curve polygon 220 are created by comparing the survey map 201 and the point cloud map 301, the road boundary closed curve polygon 210 and the building boundary closed curve polygon 220 cannot be created, for example, when there is no data of a new road 211A or a new building 221A in the survey map 201. Therefore, the point cloud of the road 211A or the building 221A cannot be labeled as it is.

In the present embodiment, the point cloud is reclassified by the point cloud reclassification unit 170. The point cloud reclassification unit 170 inputs the entire point cloud map 301 to be labeled to the classifier in an unlabeled state, reclassifies the point cloud 302, and outputs the reclassified point cloud as a labeled point cloud map.

The point cloud reclassification unit 170 determines the feature amount of the point cloud in the unlabeled state in the labeling range 310 through the use of a classifier which uses the point cloud map 301 in which the point cloud 302 in the labeling range 310 is labeled as teacher data.

For example, when there is a difference between the survey map 201 and the point cloud map 301, a new road 211A or building 221A which is not included in the survey map 201 is actually present, and a point cloud of the new road 211A or building 221A is present in the point cloud map 301, there is a similarity in color or brightness between the point cloud of the new road 211A or building 221A and the point cloud of the surrounding road 211 or building 221 present in the same labeling range 310.

Therefore, the point cloud reclassification unit 170 can classify the point cloud in the point cloud map 301 into the point cloud of the new road 211A or building 221A by the classifier, and can also perform labeling on the new road 211A or the new building 221A being not present in the survey map 201.

According to the map information processing apparatus 100 of the present embodiment, the road boundary closed curve polygon 210 is created from the survey map 201, the remaining point cloud obtained by removing the point cloud 303a in the road boundary closed curve polygon 210 from the point cloud 302 of the point cloud map 301 is extracted, and the extracted point cloud is labeled to be classified into the road point cloud 303b. Therefore, it is possible to easily label the road 211 on the point cloud map 301.

Further, the building boundary closed curve polygon 220 is created from the survey map 201, the point cloud in the building boundary closed curve polygon 220 is extracted from the point cloud 302 of the point cloud map, and labeling for classifying the extracted point cloud into the building point cloud 304a is performed. Therefore, the labeling of the building 221 can be easily performed on the point cloud map 301.

In the present embodiment, a description has been made about the case where the map information processing apparatus 100 has the point cloud reclassification unit 170, but a configuration may be adopted in which the point cloud reclassification unit 170 is omitted, and similarly, an effect can be obtained in which labeling can be easily performed.

### Second Embodiment

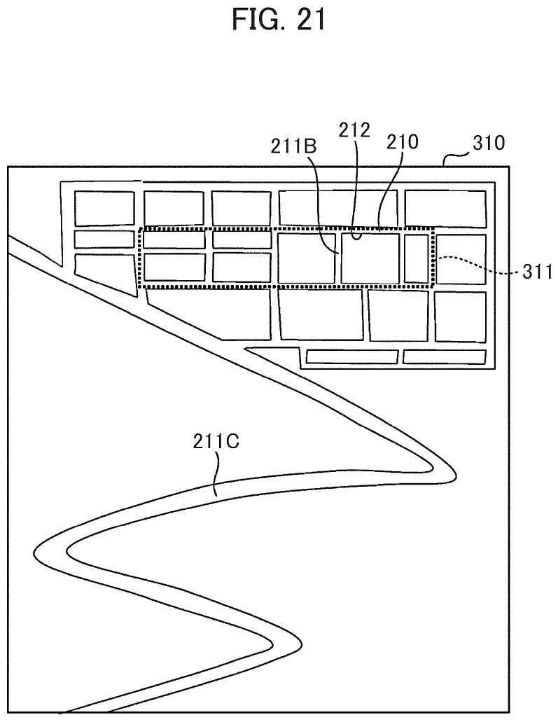

FIG. 21 is an explanatory diagram showing a second embodiment.

In the present embodiment, first, point clouds are classified within a teacher data creation range 311 in which a road boundary closed curve polygon 210 can be created, and a classifier is caused to perform machine learning with the classified point clouds as teacher data. Then, the classifier is used to classify the point cloud even in a wider labeling range 310 including a teacher data creating range 311 to thereby perform labeling for classifying the point cloud in a region in which the road boundary closed curve polygon 210 cannot be created, into a road point cloud.

As shown in FIG. 21, when there is a road 211C in which the road boundary closed curve polygon 210 such as a single road cannot be created in the labeling range 310, the boundary contour extraction unit 140 narrows down the labeling range 310 to a part of the teacher data creation range 311 in which the road boundary closed curve polygon 210 can be created, and creates the road boundary closed curve polygon 210 within such a teacher data creation range 311.

The road point cloud extraction unit 160 extracts a point cloud by making an inside/outside determination as to whether the point cloud existing in the teacher data creation range 311 of the point cloud map 301 exists either inside or outside the road boundary closed curve polygon 210, and classifies the point cloud into a structure point cloud. As shown in FIG. 18 (2), the road point cloud extraction unit 160 removes the point cloud included in the road boundary closed curve polygon 210, extracts the point cloud remaining within the teacher data creation range 311, and performs labeling to classify the extracted point cloud into a road point cloud of a road 211B.

The point cloud reclassification unit 170 acquires a point cloud map 301 having a labeled point cloud of the road 211B and causes the classifier to machine-learn the point cloud map as teacher data. Then, the entire point cloud in the labeling range 310 to be classified is input to the classifier as learning data, and the point cloud in a wider range including the teacher data creation range 311 is reclassified.

The road 211C and the road 211B are adjacent to each other, and there is a similarity in color and brightness between the point cloud of the road 211C and the point cloud of the road 211B existing in the teacher data creation range 311. After creating the classifier, the point cloud reclassification unit 170 performs classification by machine learning using the point cloud as an input in the wider labeling range 310 including the teacher data creation range 311. Therefore, the point cloud of the road 211C at the portion in which the road boundary closed curve polygon 210 cannot be created can be classified as the road point cloud on the basis of the similarity with the point cloud of the road 211B.

### Third Embodiment

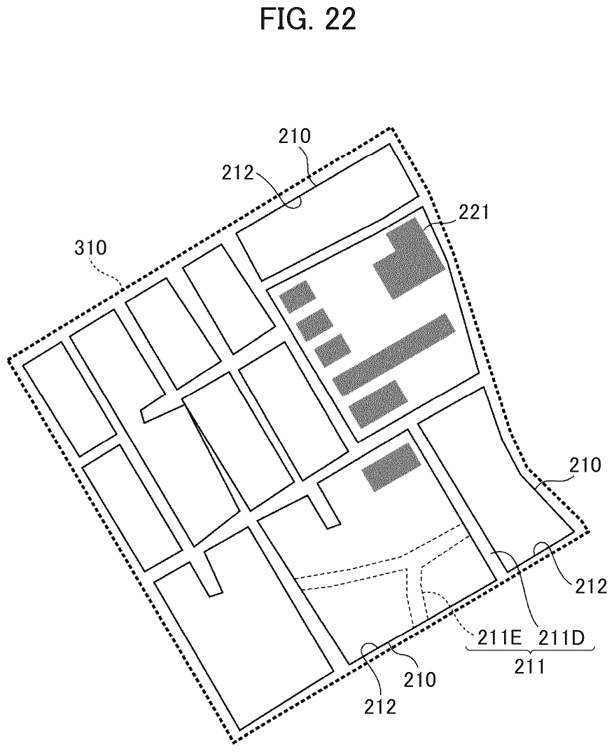

FIG. 22 is an explanatory diagram showing a third embodiment, and is a diagram showing a labeling range 310 of a survey map 201.

The present embodiment is characterized in that, when boundary line information on a roadway 211D and boundary line information on a sidewalk 211E are included as the information on the attribute of the road 211 in the survey map 201 of the survey map database 200, a point cloud 303b of the road 211 is classified into a point cloud of the roadway 211D (roadway point cloud) and a point cloud of the sidewalk 211E (sidewalk point cloud).

The survey map acquisition unit 110 acquires a survey map 201 including information on the attribute of the road 211, and the boundary contour extraction unit 140 creates a road boundary closed curve polygon 210 for each attribute of the road 211 from the survey map 201. For example, when the road 211 has the attribute of the roadway 211D and the attribute of the sidewalk 211E, the road boundary closed curve polygon of the roadway 211D including the sidewalk 211E, and the road boundary closed curve polygon of only the roadway 211D are created. Then, the road point cloud extraction unit 160 extracts a point cloud for each attribute of the road 211 using the road boundary closed curve polygon 210 created for each attribute.

The survey map acquisition unit 110 acquires a survey map 201 having information on attributes indicating a road end contour of the road 211 and a type of the road 211 including at least a distinction between the roadway 211D and the sidewalk 211E.

The boundary contour extraction unit 140 creates a road boundary closed curve polygon of the same attribute from the survey map 201. The road point cloud extraction unit 160 extracts each remaining point cloud obtained by removing the point cloud in the road boundary closed curve polygon from the point cloud map 301, and classifies the extracted point cloud into the road point cloud.

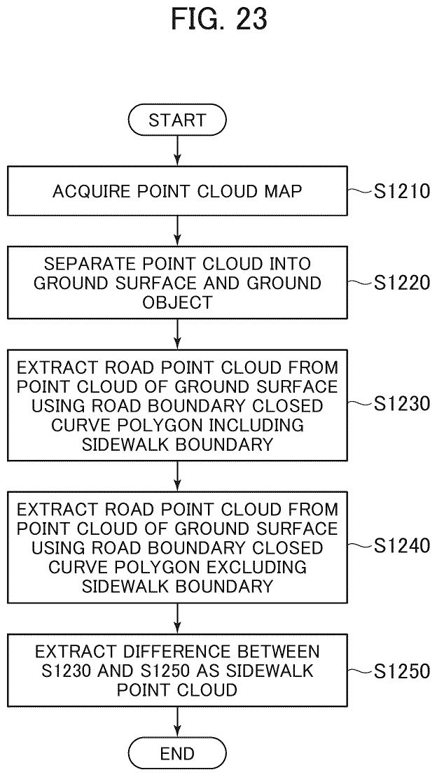

FIG. 23 is a flowchart showing processing of the road point cloud extraction unit according to the third embodiment.

The road point cloud extraction unit 160 acquires a point cloud 302 in the labeling range 310 of the point cloud map 301 from the point cloud map region extraction unit 130 (S1210). Then, similarly to the processing of S1120 shown in FIG. 15 described above, the point cloud in the point cloud acquisition region 320 is separated into the point cloud 303 of the ground surface and the point cloud 304 of the ground object by the known method (S1220).

Then, the boundary contour extraction unit 140 extracts point sequences of all the road boundaries 212 whose attributes are the roadway 211D and the sidewalk 211E from the survey map 201 to create a first road boundary closed curve polygon (first road boundary closed curve), and the road point cloud extraction unit 160 extracts a point cloud remaining after removing the point cloud in the first road boundary closed cure polygon from all the point clouds 303 of the ground surface as a first road point cloud (S1230).

Next, the boundary contour extraction unit 140 extracts a point sequence excluding the point sequence of the road boundary of the sidewalk 211E from the point sequence of all the road boundaries 212 described above to create a second road boundary closed curve polygon (second road boundary closed curve), and the road point cloud extraction unit 160 extracts a point cloud remaining after removing the point cloud in the second road boundary closed curve polygon from the point cloud 303 of the ground surface as a second road point cloud (S1240). Then, the difference between the first road point cloud and the second road point cloud is extracted, and labeling is performed to classify a point cloud of the difference into a sidewalk point cloud (S1250).

According to the map information processing apparatus 100 of the present embodiment, the point cloud in the point cloud map 301 can be classified into the road point cloud, and the road point cloud can be further classified into the roadway point cloud and the sidewalk point cloud.

Although the embodiments of the present invention have been described in detail above, the present invention is not limited to the above embodiments, and various design changes can be made within the scope not departing from the spirit of the present invention described in the claims. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

100 . . . map information processing apparatus, 110 . . . survey map acquisition unit, 120 . . . point cloud map acquisition unit, 130 . . . point cloud map region extraction unit, 140 . . . boundary contour extraction unit, 150 . . . building point cloud extraction unit (structure point cloud extraction unit), 160 . . . road point cloud extraction unit (structure point cloud extraction unit), 170 . . . point cloud reclassification unit, 201 . . . survey map, 210 . . . road boundary closed curve polygon (structure boundary closed curve), 211 . . . road, 211A . . . road, 211B . . . road, 211C . . . road, 212 . . . road boundary, 212A . . . building, 212i to 212j . . . road boundary, 220 . . . building boundary closed curve polygon (structure boundary closed curve), 221 . . . building, 222 . . . building boundary, 301 . . . point cloud map, 302 . . . point cloud, 303 . . . point cloud, 303b . . . road point cloud, 304a . . . building point cloud, 310 . . . labeling range

1. A map information processing apparatus comprising:
a point cloud map acquisition unit configured to acquire a point cloud map;
a survey map acquisition unit configured to acquire a survey map including boundary information on a structure;
a boundary contour extraction unit configured to create a structure boundary closed curve from the survey map; and
a structure point cloud extraction unit configured to extract a point cloud by an inside/outside determination as to whether the point cloud included in the point cloud map exists either inside or outside the structure boundary closed curve, and classify the extracted point cloud into a structure point cloud.

2. The map information processing apparatus according to claim 1, wherein
the survey map acquisition unit acquires a survey map including information on a road end contour of a road which is a first structure,
the boundary contour extraction unit creates a road boundary closed curve from the survey map, and
the structure point cloud extraction unit extracts a remaining point cloud obtained by removing the point cloud within the road boundary closed curve from the point cloud of the point cloud map and classifies the extracted point cloud into a road point cloud.

3. The map information processing apparatus according to claim 2, wherein
the survey map acquisition unit acquires a survey map including a building contour of a building which is a second structure,
the boundary contour extraction unit creates a building boundary closed curve from the survey map, and
the structure point cloud extraction unit extracts a point cloud existing in the building boundary closed curve from the point cloud of the point cloud map and classifies the extracted point cloud into a building point cloud.

4. The map information processing apparatus according to claim 3, wherein
the boundary contour extraction unit enlarges the building boundary closed curve created from the survey map with a centroid of the building boundary closed curve as a center, and
the structure point cloud extraction unit extracts a point cloud existing in the enlarged building boundary closed curve and classifies the extracted point cloud into the building point cloud.

5. The map information processing apparatus according to claim 1, comprising a point cloud reclassification unit configured to create a classifier which is machine-learned using the point cloud extracted by the structure point cloud extraction unit as teacher data, and reclassify the point cloud of the point cloud map using the classifier.

6. The map information processing apparatus according to claim 5, wherein
the structure point cloud extraction unit extracts a point cloud and classifies the point cloud into a structure point cloud by an inside/outside determination as to whether a point cloud existing in a teacher data creation range of the point cloud map exists either inside or outside the structure boundary closed curve, and
the point cloud reclassification unit causes the classifier to machine-learn the point cloud extracted from within the teacher data creation range as teacher date, and reclassifies a point cloud in a wider range including the teacher data creation range of the point cloud map using the classifier.

7. The map information processing apparatus according to claim 1, wherein
the survey map acquisition unit acquires a survey map including information on an attribute of the structure,
the boundary contour extraction unit creates a structure boundary closed curve for each attribute of the structure from the survey map, and
the structure point cloud extraction unit extracts the point cloud of the structure using the structure boundary closed curve created for each attribute.

8. The map information processing apparatus according to claim 7, wherein
the survey map acquisition unit acquires a survey map having a road end contour of a road which is a first structure and information on an attribute indicating a type of the road including at least a distinction between a roadway and a sidewalk,
the boundary contour extraction unit creates a road boundary closed curve of the same attribute from the survey map, and
the structure point cloud extraction unit extracts a remaining point cloud obtained by removing the point cloud in the road boundary closed curve from the point cloud map and classifies the remaining point cloud into a road point cloud.

9. The map information processing apparatus according to claim 8, wherein
the boundary contour extraction unit extracts point sequences of all road boundaries whose attributes are a roadway and a sidewalk from the survey map to create a first road boundary closed curve, and extracts point sequences excluding a point sequence of a road boundary of a sidewalk from the point sequences of all the road boundaries to create a second road boundary closed curve, and
the structure point cloud extraction unit extracts a point cloud remaining after removing the point cloud in the first road boundary closed curve from the point cloud map as a first road point cloud, extracts a point cloud remaining after removing the point cloud in the second road boundary closed curve from the point cloud map as a second road point cloud, extracts a difference between the first road point cloud and the second road point cloud, and classifies the differential point cloud into a sidewalk point cloud.
